(19) United States
(12) Patent Application Publication
(10) Pub. No.: US 2002/0028169 A1
(43) Pub. Date: Mar. 7, 2002

(54) Use of a catalyst for reducing the quantity and/or size of particulates in diesel exhaust

(76) Inventors: Lothar Puppe, Burscheid (DE); Axel Konig, Wolfsburg (DE); Ulrich-Dieter Standt, Meine (DE)

Correspondence Address: William C. Gerstenzang, Norris McLaughlin & Marcus, P.A., 30th Floor, 220 East 42nd Street, New York, NY, 10017, US

(21) Appl. No.: 09/967,271

(22) Filed: Sep. 28, 2001

Related U.S. Application Data
(63) Continuation of application No. 09/548,428, filed on Apr. 13, 2000.

(30) Foreign Application Priority Data
Aug. 7, 1992 (DE) P 42 26 111.2

(51) Int. Cl. B01D 53/72

(52) U.S. Cl. 423/213.5; 423/215.5; 423/245.3

(57) ABSTRACT

In the reduction of at least one of the quantity of hydrocarbons, and the quantity or size of particulates in the exhaust of a diesel engine, wherein said exhaust is contacted with a catalyst, the improvement wherein the catalyst comprises a combination of a zeolite having acidic properties and at least one noble metal. There may also be present at least one element from the second main group of the periodic system of elements and the rare-earth elements.

This invention relates to the use of a catalyst for reducing the quantity and/or size of particulates in the exhaust gas of a diesel engine by means of a bifunctional catalyst containing a noble metal and an acidic zeolite.

One of the problems of using diesel engines, more particularly to drive motor vehicles, is that they emit particulates which are difficult to prevent from entering the atmosphere.

A well-known measure widely used to prevent particulate emission is to use filters. The disadvantage of filters lies in the danger of blockage by the particulates after a relatively short operating time. Accordingly, measures have to be taken to regenerate the particulate filters, for example by brief heating of the filters by suitable devices to the ignition temperature of the deposited particulates. Devices such as these are complicated and expensive and are not a practical solution, for example, for diesel-powered automobiles.

It is also known that the quantity of particulates can be catalytically reduced. Oxidation catalysts containing platinum as active component on aluminum oxide are used for this purpose. The disadvantage of noble metal catalysts of this type is that, although they reduce the quantity of particulates in the exhaust gas, they also have a strong oxidizing effect on the SO₂ component of the exhaust gases. The resulting formation of sulfate makes the particulates hygroscopic and, under certain conditions, even leads to an increase in the quantity of particulates. In addition, sulfate particles are deposited on the catalyst, reducing its effectiveness.

It is known Patent application Ser. No. 836,043, filed Feb. 12, 1992, now pending, that the quantity of particulates can be reduced without additional sulfate formation. It was found that zeolite-containing catalysts with acidic or cracking properties reduce the quantity and/or size of particulates and the quantity of hydrocarbons without at the same time oxidizing the SO2 in the exhaust gas to sulfates. An unsatisfactory aspect of these zeolite-containing catalysts is the relatively low hydrocarbon conversion of around 30 to 35%.

Accordingly, the object of the present invention was to find a solution which would not be attended by the described disadvantages

It has now been found that zeolite-containing catalysts which have acidic or cracking properties and which additionally contain noble metals such as, for example, Pt, Pd, Ru, Ir, Re and Rh,distinctly reduce the quantity and/or size of particulates and the quantity of hydrocarbons without at the same time oxidizing the SO₂ in the exhaust gas to sulfates.

Now, the present invention relates to the use of a catalyst for reducing the quantity and/or size of particulates in the exhaust gas of a diesel engine by means of a noble-metal- and zeolite-containing catalyst with acidic properties.

The noble-metal- and zeolite-containing acidic catalysts used in accordance with the invention preferably have cracking and oxidizing properties. The hydrocarbon conversion rate of the noble-metal-containing acidic zeolite catalyst used in accordance with the invention is distinctly higher (approx. 50%) than that of zeolite catalysts free from noble metals.

Zeolites particularly suitable for use in accordance with the invention include the following structure types for example: faujasites, pentasils, mordenites, ZSM 12, zeolite β, zeolite L, zeolite Ω, PSH-3, ZSM 22, ZSM 23, ZSM 48, EU-1, etc.

The pentasil type zeolite preferably has an SiO₂ to Al₂O₃ ratio of 25 to 2000:1 and, more preferably 40 to 600:1.

Zeolites are characterized by the following general formula (I):

M¹_{2/n}O·xM²₂O₃·ySiO₂·qH₂O (I)

in which

M¹ is an equivalent of an exchangeable cation, n standing for the valency and the number corresponding to the charge equalization of M²,

M² is a trivalent element which, together with the Si, forms the oxidic skeleton of the zeolite,

y/x is the SiO₂/M²₂O₃ ratio,

q is the quantity of water adsorbed.

In terms of their basic structure, zeolites are crystalline alumosilicates which are made up of a network of SiO₄ and M²O₄ tetrahedrons. The individual tetrahedrons are linked to one another by oxygen bridges over the corners of the tetrahedrons and form a three-dimensional network which is uniformly permeated by passages and voids. The individual zeolite structures differ in the arrangement and size of the passages and voids and in their composition. Exchangeable cations are incorporated to equalize the negative charge of the lattice arising out of the M² component. The adsorbed water phase qH₂O can be reversibly removed without the skeleton losing its structure.

M² is often aluminum, but may be completely or partly replaced by certain other trivalent elements.

A detailed account of zeolites can be found, for example, in D. W. Breck's book entitled “Zeolite Molecular Sieves, Structure, Chemistry and Use”, J. Wiley & Sons, New York, 1974. Another account, particularly of the zeolites relatively rich in SiO₂ which are of interest in catalytic applications, can be found in the book by P. A. Jacobs and J. A. Martens entitled “Synthesis of High-Silica Aluminosilicate Zeolites”, Studies in Surface Science and Catalysis, Vol. 33, Ed. B. Delmon and J. I. Yates, Elsevier, Amsterdam/Oxford/New York/Tokyo, 1987.

In the zeolites used in accordance with the invention, M² stands for one or more elements from the group consisting of Al, B, Ga, In, Fe, Cr, V, As and Sb and, preferably, for one or more elements from the group consisting of Al, B, Ga and Fe.

The zeolites mentioned may contain rare earths and/or protons as exchangeable cations M¹. Other suitable exchangeable cations are, for example, those of Mg, Ca, Sr, Ba, Zn, Cd and also transition metal cations such as, for example, Cr, Mn, Fe, Ni, Co, Cu, V, Nb, Mo, Ru, Rh, Pd, Ag, Ta, W, Re and Pt.

According to the invention, preferred zeolites are those of the structure types mentioned above, in which at least part, preferably 50 to 100% and, more preferably, 80 to 100% of all the metal cations originally present have been replaced by hydrogen ions, and which contain metals of the noble metal groups in addition to the hydrogen ions. Acidic zeolites of the above-mentioned structure types which contain Ru, Rh. Pd, Re, Ir or Pt are particularly preferred.

These noble metals are introduced into the zeolites, which may be present in granulated form or even as an active layer on a hone) comb, in accordance with the prior art as described, for example, in Metal Microstructures in Zeolites, Preparation - Properties - Applications, Studies in Surface Science and Catalysis, Vol. 12, Ed. P. A. Jacobs, N. I. Jaeger, P. Jiru and G. Schulz-Ekloff, Elsevier, Amsterdam/Oxford/New York, 1 982. Impregnation of the zeolite-containing catalyst with a noble metal salt is also suitable. The zeolite-containing catalysts according to the invention may contain 0.05 to 2% by weight and preferably 0.1 to 1% by weight of a noble metal.

The acidic H⁺ forms of the zeolites are preferably produced by exchanging metal ions for ammonium ions and subsequently calcining the zeolite thus exchanged. In the case of zeolites of the faujasite type, repetition of the exchange process and subsequent calcination under defined conditions lead to so-called ultrastable zeolites which are made thermally and hydrothermally more stable by this dealuminization process. Another method of obtaining zeolites of the faujasite type rich in SiO₂ is to subject the anhydrous zeolite to a controlled treatment with SiCl₄ at relatively high temperatures (≧150° C.). As a result of this treatment, aluminum is removed and at the same time silicon is incorporated in the lattice. Under certain conditions, treatment with ammonium hexafluorosilicate also leads to a faujasite rich in SiO₂.

Another method of replacing/exchanging protons is to carry out the process with mineral acids in the case of zeolites which have a sufficiently high SiO₂ to Al₂O₃ ratio (>5)

It is also known that ion exchange with trivalent rare earth metal ions (individually and/or in the form of mixtures) which may preferably be rich in lanthanum or cerium, leads to acidic centers, above all in the case of faujasite. It is also known that acidic centers are formed when polyvalent metal cations are introduced into zeolites.

The following example illustrates the effectiveness of using a noble-metal-containing, acidic zeolite catalyst in particulate conversion and hydrocarbon conversion. The example is not intended to limit the invention in any way.

### EXAMPLE

A catalyst containing H zeolite Y with a molar SiO₂ to Al₂O₃ ratio of 60:1 and containing 0.1% by weight Pt, based on the total weight of the catalyst, was fitted to a Passat Variant with a 55 Kw “environment friendly” diesel engine. The results were obtained on a roller-type test bench (according to US 75). The fuel used was a European reference diesel fuel containing 0.05% sulfur.

The following test results were obtained:

| | | Particulate reduction |
|---|---|---|
| | HC conversion (%) | (%) |
| Example | 47 | 29 |

### Comparison Example

The above Example was repeated using a catalyst containing H zeolite Y with a molar SiO₂ to Al₂O₃ ratio of 60 and with no noble metal.

The following test results were obtained:

| | | Particulate reduction |
|---|---|---|
| | HC conversion (%) | (%) |
| Example | 35 | 28 |

It will be understood that the specification and examples are illustrative but not limitative of the present invention and that other embodiments within the spirit and scope of the invention will suggest themselves to those skilled in the art.

1. In the reduction of at least one of the quantity of hydrocarbons, and the quantity or size of particulates in the exhaust of a diesel engine, wherein said exhaust is contacted with a catalyst, the improvement wherein the catalyst comprises a combination of a zeolite having acidic properties and at least one noble metal:

2. The method according to claim 1, wherein the zeolite is of the faujasite type.

3. The method according to claim 1, wherein the zeolite is a dealuminized faujasite.

4. The method according to claim 1, wherein the zeolite is of the pentasil type.

5. The method according to claim 4, wherein the pentasil type zeolite has an SiO₂ to Al₂O₃ ratio of 25.1 to 2000:1.

6. The method according to claim 4, wherein the pentasil type zeolite has an SiO₂ to Al₂O₃ ratio of 40:1 to 600:1.

7. The method according to claim 1, wherein the zeolite is of the mordenite type.

8. The method according to claim 7, wherein the zeolite is a dealuminized mordenite.

9. The method according to claim 1, wherein the zeolite additionally contains as exchanged cations at least one element from the second main group of the periodic system of elements and the rare earth elements.

10. The method according to claim 1, wherein the zeolite contains as exchanged cations at least one transition element.

11. The method according to claim 1, wherein the zeolite contains at least one of Cu, Ni, Co, Fe, Cr, Mn and V.

12. The method according to claim 1, wherein the zeolite contains Cu.

13. The method according to claim 1, wherein the noble metal is present in about 0.05 to 2% by weight, based on the catalyst as a whole.

14. The method according to claim 1, wherein the noble metal is selected from the group consisting of Ru, Rh, Pd, Re, Ir and Pt.
